(19) United States
(12) Patent Application Publication
(10) Pub. No.: US 2026/0317557 A1
(43) Pub. Date: Oct. 15, 2026

(54) SEMI-RIGID POLYURETHANE POTTANT COMPOSITIONS AND METHODS FOR PREPARING SAME

(71) Applicant: DOW GLOBAL TECHNOLOGIES LLC, Midland, MI (US)

(72) Inventors: Degang Zhang, Shanghai (CN); Yanil Feng, Sugarland, TX (US); Ping Zhang, Shanghai (CN)

(21) Appl. No.: 19/485,440

(22) PCT Filed: Jun. 30, 2023
(86) PCT No.: PCT/CN2023/105070

§ 371 Date: Nov. 18, 2025

(51) Int. Cl. C09D 5/18; C08G 18/32; C08G 18/48; C08G 18/66; C08G 18/76; C09D 7/45; C09D 7/61; C09D 7/65; C09D 175/08; H01M 50/588; H01M 50/59

(52) U.S. Cl. CPC C09D 5/18; C08G 18/3206; C08G 18/4837; C08G 18/6674; C08G 18/7671; C09D 7/45; C09D 7/61; C09D 7/65; C09D 175/08; H01M 50/588; H01M 50/59; C08G 2110/005; C08G 2110/0058; C08G 2150/60

(57) ABSTRACT

Polyurethane compositions include a reaction product of: an isocyanate component comprising one or more isocyanate compounds; and an isocyanate-reactive component including: one or more polyether polyols comprising at least one capped polyether polyol having an OH functionality of 3 to 6, and an EO content of 10 wt % to 25 wt %; one or more polyol crosslinkers having a hydroxyl functionality of 2 or more; and one or more solid flame resistance (FR) additives in at least one of the isocyanate component, the isocyanate-reactive component, or a third component; wherein the polyurethane composition has a hardness of 20 Shore A or more. Methods include preparing polyurethane compositions that include combining the isocyanate component and the isocyanate-reactive component to form a mixture; and reacting the mixture to form the polyurethane composition.

### FIELD

Embodiments relate to flame resistant polyurethane compositions, methods for preparing and applications utilizing same.

### BACKGROUND

Electric vehicles (EV) operate with a battery pack and the individual cells are arranged in different patterns along with cooling mechanism related components and other parts in the vicinity. Battery cell geometry can take on many forms including cylindrical, rectangular/prismatic, pouch, and combinations that are layered and organized to increase energy density. Gaps between battery elements are filled with a pottant material (usually polyurethane or silicone), which isolates battery cells thermally and augments battery assembly strength under various use conditions such as vibration, high temperature and high humidity.

Polyurethane-based foams are often employed in the automotive industry as pottants to reduce weight to improve efficiency and handling. However, PU-based pottant materials should be strong enough to bond the batteries cells together and resistant to heat and open flame, and there are often performance tradeoffs with less dense foam materials. In order to meet the flame resistance requirements of the industry, various standards are applied to quantify flammability of plastics, such as the Standard for Safety of Flammability of Plastic Materials UL 94. To achieve desired fire performance, standard flame resistance (FR) additives are applied to pottant formulations in relatively large amounts, which can affect physical properties such as modulus and hardness. For example, liquid FR additives such as phosphate esters often make up substantial percentages of the formulation weight (e.g., 15 wt % to 60 wt % or more), which impacts foaming balance during polyurethane formation and ultimately foam quality and density. Liquid FR additives may also function as a plasticizer, and significantly alter the physical properties of a foam under high temperature.

### SUMMARY

Embodiments disclosed herein include polyurethane compositions, including a reaction product of: an isocyanate component comprising one or more isocyanate compounds; and an isocyanate-reactive component including: one or more polyether polyols comprising at least one capped polyether polyol having an OH functionality of 3 to 6, and an EO content of 10 wt % to 25 wt %; one or more polyol crosslinkers having a hydroxyl functionality of 2 or more; and one or more solid flame resistance (FR) additives in at least one of the isocyanate component, the isocyanate-reactive component, or a third component; wherein the polyurethane composition has a hardness of 20 Shore A or more.

### DETAILED DESCRIPTION

Embodiments relate to polyurethane foams and compositions having flame resistant properties, and suitable for generating semi-rigid potting and thermally insulating materials. Embodiments relate to polyurethane (PU) compositions for pottant and electronic materials having an isocyanate-reactive component that includes a mixture of polyether polyol, polyol crosslinker, solid flame resistance (FR) additive, and other additives. PU compositions may be semi-rigid (i.e., Shore A hardness greater than 20) and may produce foams suitable for use as pottants having a flammability rating according to UL-94 of V1 or better, and low thermal conductivity (<0.10 W/m*K).

Compositions disclosed herein include two-part polyurethane compositions for use as pottants and encapsulants useful in a number of electronics and electric vehicle (EV) battery applications. PU compositions are formulated with solid FR additives that have improved properties when compared with polyurethanes formulated with liquid FR additives that negatively affect physical strength, particularly at elevated temperatures. Articles and pottants prepared according to the present disclosure may exhibit a UL-94 vertical burn rating of V1 or better and ≤0.1 W/m*K thermal conductivity, while also maintaining high temperature strength (i.e., elongation at break ≥10%, hardness and storage modulus retention ≥60%).

PU compositions disclosed herein generally include the product obtained from combining a two-component curable composition: an isocyanate component (“A-side”) and an isocyanate-reactive component (“B-side”). During application, the isocyanate and isocyanate-reactive components are mixed, initiating a curing reaction, and forming a polyurethane article or material. PU compositions may also include one or more solid FR additives added to the isocyanate and/or isocyanate-reactive components, or as a third component added during mixing.

Isocyanate components may contain one or more isocyanate compounds, such as polymeric isocyanates, aromatic isocyanates, or carbodiimide-modified isocyanates. Isocyanate compounds may be monomeric, oligomeric, prepolymers, and the like. The isocyanate component can include, for example, one or more isocyanate and/or polyisocyanate compounds. Isocyanate components may include isocyanate compounds having a nominal functionality of 1.5 or greater, or ≥2.0 or greater.

The isocyanate component may include an isocyanate compound having a number average molecular weight of 150 g/mol to 750 g/mol. In some cases, the isocyanate compound can have a number average molecular weight from a low value of 150 g/mol, 200 g/mol, 250 g/mol or 300 g/mol to an upper value of 350 g/mol, 400 g/mol, 450 g/mol, 500 g/mol or 750 g/mol. The number average molecular weight values reported herein are determined by end group analysis, gel permeation chromatography, and other methods as is known in the art. The isocyanate compound can be monomeric and/or polymeric, as are known in the art.

The isocyanate component may include one or more of aliphatic polyisocyanate, cycloaliphatic polyisocyanate, araliphatic polyisocyanate, aromatic polyisocyanate, and the like. Examples of isocyanates include, but are not limited to, methylenediphenyl diisocyanate (MDI, including its isomers); polymeric or oligomeric MDI, or modified MDI; triisocyanatononane (TIN); naphthyl diisocyanate (NDI); 4,4′-diisocyanatodicyclohexyl-methane; 3-isocyanatomethyl-3,3,5-trimethylcyclohexyl isocyanate (isophorone diisocyanate, IPDI); tetramethylene diisocyanate; hexamethylene diisocyanate (HDI); 2-methyl-pentamethylene diisocyanate; 2,2,4-trimethylhexamethylene diisocyanate (THDI); dodecamethylene diisocyanate; 1,4-diisocyanatocyclohexane; 4,4′-diisocyanato-3,3′-dimethyl-dicyclohexylmethane; 4,4′-diisocyanato-2,2-dicyclohexylpropane; 3-isocyanatomethyl-1-methyl-1-isocyanatocyclohexane (MCI); 1,3-diisooctylcyanato-4-methylcyclohexane; 1,3-diisocyanato-2-methylcyclohexane; and combinations thereof, among others. In addition to the isocyanates mentioned above, partially modified polyisocyanates including uretdione, isocyanurate, carbodiimide, uretonimine, allophanate or biuret structure, and combinations thereof, among others, may be utilized. Examples of commercial isocyanates include, but are not limited to, polyisocyanates under the trade names VORANATE™, VORATRON™, PAPI™, VORAFORCE™ and ISONATE™ available from Dow Chemical Company.

Isocyanate compounds may include isocyanate prepolymers resulting from reaction of an isocyanate-reactive compound with a molar excess of an isocyanate compound or polymeric isocyanate compound under conditions that do not lead to gelation or solidification, the isocyanate prepolymers can have a higher average isocyanate equivalent weight of >140 g/eq. Formation of isocyanate prepolymers is known in the art, and may include reacting (1) at least one isocyanate compound and (2) at least one polyol compound. Isocyanate prepolymers may be described by an NCO %, corresponding to the weight percent of NCO groups, remaining after completion of the reaction between isocyanate and isocyanate-reactive compound, that are present in the prepolymer. Isocyanates components disclosed herein may include one or more isocyanate compounds having an NCO content at a percent by weight of above 20 wt %, such as in a range of 20 wt % to 50 wt %, or 20 wt % to 48 wt %.

The isocyanate component includes at least one isocyanate group containing material (such as a polyisocyanate and/or isocyanate-terminated prepolymer). For example, the isocyanate component includes at least one aromatic polyisocyanate, such as methylene diphenyl diisocyanate (MDI) and/or its oligomers, modified MDI, or polymeric MDI, and/or toluene diisocyanate (TDI). The isocyanate component can include at least 50 wt % (at least 60 wt %, at least 70 wt %, at least 80 wt %, at least 90 wt %, at least 95 wt %, at least 98 wt %, etc.) of one or more polyisocyanates, based on a total weight of the isocyanate component. In some cases, the isocyanate component may include a polyisocyanates a percent by weight (wt %) in a range of 30 wt % to 100 wt %.

PU compositions disclosed herein may include an isocyanate component at a percent by weight (wt %) ranging from 15 wt % to 80 wt %, 20 wt % to 80 wt %, or 20 wt % to 70 wt %.

Isocyanate-reactive component that includes a mixture of polyether polyol, polyol crosslinker (or polyol chain extender), solid flame resistance (FR) additive, surfactants, an optional catalyst, and other additives. Polyurethane compositions may include an isocyanate-reactive component at a percent by weight (wt %) ranging from 20 wt % to 85 wt %, 20 wt % to 80 wt %, or 25 wt % to 80 wt %.

Isocyanate-reactive components may include one or more polyether polyols prepared by polyaddition of alkylene oxides such as propylene oxide (PO) and/or ethylene oxide (EO) onto polyhydroxy functional starter compounds in the presence of catalysts known in the art. Polyether polyols may have a functionality in the range of 1 to 8, 2 to 8, or 2 to 6. In some cases, polyether polyols may have a primary OH content of 50% or more. Polyether polyols may have a hydroxyl number in the range of 15 mg KOH/g to 100 mg KOH/g, 20 mg KOH/g to 75 mg KOH/g, or 20 mg KOH/g to 60 mg KOH/g. Polyether polyols may have a number average molecular weight (Mn) of 3000 Da to 11000 Da, 3500 Da to 10000 Da, or 4000 Da to 9000 Da.

Polyether polyols may be prepared from a starter compound and one or more alkylene oxides, including ethylene oxide, propylene oxide, and/or butylene oxide. Starter compounds may include, but are not limited to, molecules having 1 to 8 hydroxyl groups per molecule, such as ethylene glycol, propylene glycol, diethylene glycol, dipropylene glycol, triethylene glycol, tripropylene glycol, 1,4-butanediol, 1,6-hexanediol, triethanolamine, diethanolamine, diisopropanolamine, bisphenol A, glycerol, diglycerol, triglycerol, trimethylolpropane, di(trimethylolpropane) pentaerythritol, dipentaerythritol, tripentaerythritol, sugars and sugar alcohols such as sucrose and sorbitol, and the like. Polyether polyols can also be a blend of any of these polyether polyols together with one or more starter compounds, and the polyether polyols can also be one or more starter compounds themselves.

Polyether polyols may include copolymers of EO, PO, and/or additional monomers, including polymers and copolymers further reacted (or “capped”) with hydroxyethyl and/or hydroxypropyl oligomers or polymers. The polyether polyols may include EO as a percent by weight of the constituent alkylene oxides (wt %) in a range of 5 wt % to 30 wt %, 10 wt % to 30 wt %, or 10 wt % to 25 wt %. In some cases, the polyether polyol is or includes at least one polyoxyethylene (EO) capped polyoxypropylene or polyoxypropylene/polyoxyethylene (PO/EO) polyether polyol having an EO content of 10 wt % to 25 wt %, an OH functionality of 3 to 6, a hydroxyl number in the range of 20 mg KOH/g to 60 mg KOH/g, and a primary OH content of 50% or more.

The isocyanate-reactive component may include at least one polyether polyol present at a percent by weight (wt %) from 25 wt % to 95 wt %, 30 wt % to 95 wt %, or 30 wt % to 90 wt %.

Isocyanate-reactive components may include one or more polyol crosslinkers having a hydroxyl functionality of at least 2 and a weight average molecular weight of 800 g/mol or less. In some cases, polyol crosslinkers having a hydroxyl functionality of 2 may function as chain extenders. Suitable polyol crosslinkers may include glycerol, diglycerol, triglycerol, ethylene glycol, trimethylolpropane, di(trimethylolpropane), pentaerythritol, dipentaerythritol, tripentaerythritol, sorbitol, derivatives like alkoxylates, or combinations thereof.

Polyol crosslinkers may have a hydroxyl number in a range of 400 mg KOH/g to 2500 mg KOH/g, 500 mg KOH/g to 2500 mg KOH/g, or 500 mg KOH/g to 2000 mg KOH/g.

Isocyanate-reactive components may include one or more polyol crosslinkers (or chain extenders) at a percent by weight (wt %) of 1 wt % to 25 wt %, 2 wt % to 25 wt %, or 3 wt % to 20 wt %.

Polyurethane compositions may include one or more solid FR additives to improve flame resistance. Suitable solid FR additives may include carbon-based additives such as expandable graphite, carbon black, graphene; aluminum-based additives such as aluminum hypophosphite, hydrated aluminum hydroxide, phosphate salts of various amines such as ammonium polyphosphate, trioctyl, tributyl or tris-butoxyethyl phosphate ester, and akylphosphate oligomers, silicates such as wollastonite, platinum compounds, carbonates such as calcium carbonate, red phosphorus, sodium citrate, and the like. In some cases, the solid FR additives may be one or more of expandable graphite, aluminum hypophosphite, and ammonium polyphosphate.

Solid FR additives may be added to an isocyanate-reactive component at a percent by weight (wt %) up to 55 wt %, or in a range of 10 wt % to 55 wt %, 20 wt % to 50 wt %, or 20 wt % to 40 wt %. In some cases, the solid FR additive is present at a percent by weight of the total PU composition (wt %) ranging from 5 wt % to 35 wt %, or 10 wt % to 30 wt %.

The amount of flame resistance can vary depending on factors such as the flame resistance selected and intended use of the polyurethane compositions to achieve the UL-94 vertical burn performance of V2 or better, and more preferably V1 or better, and most preferably V0. Flame resistance(s) and mixtures may be added to one or more of the isocyanate components and/or the isocyanate-reactive component.

PU compositions may include one or more surfactants, such as silicone-based surfactants, polyether-modified silicone surfactants, and organic-based surfactants. Suitable surfactants include polysiloxane polyoxylalkylene block copolymers, organic surfactants containing polyoxyethylene-polyoxybutylene block copolymers, and the like. Other surfactants include polyethylene glycol ethers of long-chain alcohols, tertiary amine or alkanolamine salts of long-chain allyl acid sulfate esters, alkylsulfonic esters, alkyl arylsulfonic acids, and combinations thereof. Some commercially available surfactants useful in the isocyanate-reactive composition include VORASURF™ DC 193, VORASURF™ 504, TEGOSTAB® B8418, and mixtures thereof.

Isocyanate-reactive components may include one or more silicone surfactant at a percent by weight (wt %) of 0.05 wt % to 5 wt %, 0.05 wt % to 2.5 wt %, or 0.05 wt % to 2 wt %.

Foam-forming PU compositions may include one or more blowing agents, including water and aqueous fluids; chemical blowing agents, such as hydrocarbons, acids, volatile organics, and the like; and physical blowing agents including gases such as nitrogen, air, carbon dioxide, and the like. Blowing agents may be added to the foam-forming composition during mixing at a percent by weight (wt %) ranging from 0.05 wt % to 15 wt %, or 0.05 wt % to 10 wt %, or 0.05 wt % to 5 wt %. Blowing agents may be added to the isocyanate component and/or the isocyanate-reactive component in amount sufficient to provide the mixture with the corresponding weight percentages above.

Isocyanate-reactive components may include one or more catalysts for enhancing polyurethane polymerization to generate the PU composition. Catalysts may be used individually or as a catalyst package containing multiple catalysts, such as gelling catalysts, blowing catalysts, and trimerization catalysts. Gelling and blowing catalysts may be differentiated by a tendency to favor either the urethane (gel) reaction, in the case of the gelling catalyst, or the urea (blow) reaction, in the case of the blowing catalyst. A trimerization catalyst may be utilized to promote the isocyanurate forming reaction in the compositions. The catalyst package can also be added as a separate stream into the reaction mixture of isocyanate and isocyanate-reactive composition.

Gelling catalysts include organometallic compounds, cyclic tertiary amines and/or long chain amines, e.g., that contain several nitrogen atoms and combinations thereof. Organometallic compounds include organotin compounds, such as tin (II) salts of organic carboxylic acids, e.g., tin (II) diacetate, tin (II) dioctanoate, tin (II) diethylhexanoate, and tin (II) dilaurate, and dialkyltin (IV) salts of organic carboxylic acids, e.g., dibutyltin diacetate, dibutyltin dilaurate, dibutyltin maleate and dioctyltin diacetate. Bismuth salts of organic carboxylic acids may also be utilized as the gelling catalyst, such as, for example, bismuth octanoate. Cyclic tertiary amines and/or long chain amines include dimethylbenzylamine, triethylenediamine, and combinations thereof. Examples of a commercially available gelling catalysts are POLYCAT® 8, DABCO® 33-LV, and DABCO® T-12 from Evonik, among other commercially available gelling catalysts.

Blowing catalysts may include bis-(2-dimethylaminoethyl) ether, pentamethyldiethylenetriamine, triethylamine, tributyl amine, N,N-dimethylaminopropylamine, dimethylethanolamine, N,N,N′,N′-tetra-methylethylenediamine, and combinations thereof, among others. An example of a commercial blowing catalyst is POLYCAT″ 5, from Evonik, among other commercially available blowing catalysts.

Trimerization catalysts may include any such catalysts known in the art. Examples of trimerization catalysts include N,N′,N″-tris(3-dimethylaminopropyl) hexahydro-S-triazine; N,N-dimethylcyclo-hexylamine; 1,3,5-tris(N,N-dimethylaminopropyl)-s-hexahydrotriazine; [2,4,6-tris(dimethylaminomethyl) phenol]; potassium acetate, potassium octoate; tetraalkylammonium hydroxides such as tetramethylammonium hydroxide; alkali metal hydroxides such as sodium hydroxide; alkali metal alkoxides such as sodium methoxide and potassium isopropoxide; and alkali metal salts of long-chain fatty acids having 10 carbon atoms to 20 carbon atoms, and combinations thereof, among others. Some commercially available trimerization catalysts include, for example, DABCO® TMR-2, DABCO® TMR-20, DABCO® TMR-30, DABCO® TMR-7, DABCO® K 2097; DABCO® K15, POLYCAT® 41, and POLYCAT® 46, each from Evonik, among other commercially available trimerization catalysts.

Catalysts may include a “latent catalyst” or “delayed catalyst,” which is defined as a catalyst compound that is of low catalytic activity or is relatively inactive at ambient temperatures, and which becomes more catalytically active, such as by disassociation, decoordination, ring opening, ionization, or tautomerization upon heating to effect catalysis of least one of the chemical reactions involved in making a PU foam. Ambient temperatures may range 15° C. to 35° C., where room temperature is often around 23° C.

Latent/delayed catalysts can be gelling, blowing, and/or trimerization types of catalysts in terms of their function in the foaming process. The latent catalyst is often a subset of tertiary amine gelling catalysts (e.g., delayed action tertiary amine based on 1,8-Diazabicyclo[5.4.0]undec-7-ene) that include acid salts, phenolic salts, or complexes of a tertiary amine catalyst where the acid or phenolic is often a carboxylic acid or phenol species, but not limited to, such as formic acid, acetic acid, propionic acid, 2-ethylhexanoic acid, phenoxyacetic acid, gluconic acid, tataric acid, citric acid, phenol, nonylphenol, diisopropyl phenol, and the like; and mixtures thereof. Some useable commercially available latent catalysts include, for example, DABCO® TMR-30, POLYCAT® SA2 LE, POLYCAT® SA-1/10, and DABCO® 8154 from Evonik; NIAX™ A-107, NIAXTMC-31, and NIAXTMC-225 from Momentive; and JEFFCAT™ ZF-54, JEFFCAT™ LED-204 from Huntsman Corporation; and mixtures thereof.

The catalyst or catalyst package may be present in the PU composition at a percent by weight (wt %) ranging from 0.1 wt % to 5 wt %, or 0.1 wt % to 2 wt %. In some cases, a catalyst package may be added to the isocyanate-reactive component in amount sufficient to provide the mixture with the corresponding weight percentages above.

The isocyanate-reactive component may also contain one or more additives including blowing agents, surfactants, crosslinkers, plasticizers, smoke suppressants, fragrances, reinforcements, dyes, colorants, pigments, preservatives, odor masks, physical blowing agents, chemical blowing agents, flame resistances, internal mold release agents, biocides, antioxidants, UV stabilizers, antistatic agents, thixotropic agents, adhesion promoters, cell openers, and the like.

While formulation components have been disclosed individually, it is envisioned that component elements (e.g., compounds in isocyanate or isocyanate-reactive components) may be included, excluded, or combined in any manner or subcombination utilizing any of the above concentration ranges and nested subranges therein.

PU compositions disclosed herein may have a flame resistance according to UL 94 Standards, vertical burn of V2 or better, or V1 or better.

PU compositions may have a thermal conductivity suited for the intended application. In some cases, such as automotive applications the thermal conductivity may be less than or equal to 0.2 W/m·K, while other applications the thermal conductivity may be higher such as less than or equal to 0.5 W/m·K, 0.4 W/m·K, or 0.3 W/m·K.

PU compositions may have a density according to ASTM D3574-17 Test A of less than 1 g/mL, or in a range of 0.2 g/mL to 1.2 g/mL, or 0.3 g/mL to 1.0 g/mL.

PU compositions may have an elongation at break according to ASTM 3574-17 Test E of 10% or greater, 15% or greater, or 20% or greater.

PU compositions may have a hardness according to ASTM D-2240-21 (25° C.) of 20 Shore A or greater, 40 Shore A or greater, or 45 Shore A or greater.

PU compositions may have a hardness retention, defined as 100×[storage modulus at 90° C.]/[storage modulus at 25° C.], of 55% or greater, 60% or greater, or 65% or greater.

PU compositions may have a storage modulus retention, defined as 100× [storage modulus at 90° C.]/[storage modulus at 25° C.], of 55% or greater, 60% or greater, or 65% or greater.

While formulation components and properties have been disclosed individually, it is envisioned that component elements (e.g., compounds in isocyanate or isocyanate-reactive components) may be included, excluded, or combined in any manner or subcombination utilizing any of the above concentration ranges and nested subranges therein. Further, that the recited formulation properties may be similarly achieved through various combinations of the recited components within the recited ranges.

PU compositions may be formed generally by combining the isocyanate component and the isocyanate-reactive component to form a mixture by a suitable method (e.g., static mixing, dynamic mixing, dynamic and static mixing, speedmixing, low pressure mixing, overhead mixing with impellers or paint mixers, impingement mixing, and others), and reacting the mixture to form a PU article. PU compositions may be used in any suitable process for developing articles and composites, including molding, injection, vacuum infusion, and the like. Methods may include applying PU compositions to a substrate by dispensing or coating using spin coating, brush coating; drop coating; spray coating; dip coating; roll coating; flow coating; slot coating; gravure coating; Meyer bar coating; and the like. In some cases, methods may include combining the isocyanate component and the isocyanate-reactive component to form a mixture, applying the mixture to a substate, and reacting the mixture to form a polyurethane article or composite (e.g., coating, encapsulant, pottant).

Methods may include preparing the polyurethane composition by combining the isocyanate component and the isocyanate-reactive component to form a mixture; and reacting the mixture to form the polyurethane composition. Composite articles may be prepared by disposing a composition on a substrate, and curing the composition to produce the composite article comprising a polyurethane article on the substrate. In some cases, substrates may define at least one gap, and disposing may include placing the composition in the at least one gap such that the polyurethane article is present within the gap in the composite article.

In some cases, polymer systems may be formulated as a low viscosity (e.g., <20 Pa·s, such as 2 Pa·s to 10 Pa·s) foam-forming compositions containing a modified filler at a percent by weight of less than 60 wt %, such as ranging from 10 wt % to 60 wt % filler. Foams produced that contain modified filler can be used in applications known in the industry. For example, as flexible foams used in applications such as vehicle parts, including seats, armrests, dashboards or instrument panels, sun visors, door linings, noise insulation parts, shoe soles, cloth interliners, appliance, furniture, bedding, and the like.

Polymer systems may also be formulated as high viscosity (e.g., >20 Pa·s) with higher concentrations of modified filler (e.g., greater than 60 wt %, 70%, or 80%).

PU compositions disclosed herein may be used as a pottant or thermal barrier for electrical, battery pack and/or module related applications. Pottants may coat, encapsulate (completely or partially), and/or protect the electrical connections from the abusive environments such as heat, cold, flame, weather elements, dust (e.g., sand or dirt particles), physical impact or vibration, or other abusive elements. The amount of pottant used may be from a minimum quantity sufficient for coating and protecting the electrical connections up to and including a maximum quantity sufficient to fill voids in a battery cell, junction boxes, and the like. PU compositions may also be applied in stationary energy storage applications in private and commercial settings. PU compositions may be formulated to satisfy constraints for automotive and mobility solutions (e.g., EV), but may be modified outside of those constraints for other related electrical and stationary energy storage applications. For example, a stationary storage applications may be formulated at higher densities/weights (>1 g/mL) and higher thermal conductivities (e.g., >0.2 W/m·K), where concerns regarding overall weight and the absence of external cooling are not a driving factor.

While formulation components and properties have been disclosed individually, it is envisioned that component elements (e.g., compounds in isocyanate or isocyanate-reactive components) may be included, excluded, or combined in any manner or subcombination utilizing any of the above concentration ranges and nested subranges therein. Further, that the recited formulation properties may be similarly achieved through various combinations of the recited components within the recited ranges.

The numerical ranges disclosed herein include all values from, and including, the lower and upper value and all values in between. Unless stated to the contrary, implicit from the context, or customary in the art, all parts and percentages are based on weight and all test methods are current as of the filing date of this disclosure.

### EXAMPLES

The following examples are provided to illustrate the embodiments of the invention, but are not intended to limit the scope thereof. Table 1 provides the materials used in the following examples.

TABLE 1
Materials used in the examples

| Ingredient | | |
|---|---|---|
| Type | Component | Source |
| Polyol 1 | Glycerol-initiated EO/PO copolymer, f = | Dow |
| | 3; OHv = 29 mg KOH/g, primary OH = | Chemical |
| | 80%, EO content = 15% | Company |
| Polyol 2 | Glycerol-initiated PO-based polyol, | Dow |
| | OHv = 240 mg KOH/g | Chemical |
| | | Company |
| Crosslinker 1 | Glycerine | Sinopharm |
| Crosslinker 2 | Ethylene glycol | Sinopharm |
| Crosslinker 3 | Ethylene diamine-initiated PO-based | Dow |
| | polyol, Ohv = 800 mg KOH/g | Chemical |
| | | Company |
| Crosslinker 4 | Triethanolamine | Simopharm |
| Silicone | B8734LF2 Silicone surfactant | Evonik |
| surfactant 1 | | |
| Silicone | DC5160 Silicone surfactant | Dow |
| surfactant 2 | | Chemical |
| | | Company |
| Catalyst 1 | Dabco 33 LV Amine catalyst | Evonik |
| Blowing agent | water | |
| 1 | | |
| Liquid FR | Triethyl phosphate (TEP) | Wansheng |
| Additive - 1 | | |
| Liquid FR | Tris(1-chloro-2-propyl) phosphate (TCPP) | Wansheng |
| Additive - 2 | | |
| Solid FR | Aluminum hypophosphite (AlHP) | Simopharm |
| Additive-1 | | |
| Solid FR | Expandable graphite; 80 mesh; 250-300 | Tengshengda |
| Additive-2 | expandable ratio | |
| Solid FR | Ammonium polyphosphate (APP) | Simopharm |
| Additive-2 | | |
| Isocyanate 1 | Polymeric MDI, f = 2.7; NCO % = 31.4 | Dow |
| | | Chemical |
| | | Company |

### Example 1: Properties of Polyurethane Compositions

In this example, polyurethane foam samples were prepared using comparative formulations that varied the amounts of liquid FR additives or combination of liquid FR additives and solid FR additives and analyzed against inventive foam samples containing solid FR additives. Formulations are shown in Tables 2-4.

Samples were prepared by dispersing ingredients for the isocyanate-reactive component using a DAC 600.1 FVZ-K speedmixer. FR additives were then combined with the isocyanate-reactive component until homogenous. The corresponding isocyanate was then added in the appropriate ratio. The formed mixture was then added into a 400×400×20 mm mold in a temperature range of 50-70° C. After 20-30 minutes, foam samples were demolded and cured at room temperature for at least 12 hours before testing.

TABLE 2
Formulations of comparative samples C1-C5 for Example 1

| Component | C1 | C2 | C3 | C4 | C5 |
|---|---|---|---|---|---|
| Isocyanate-reactive Component | | | | | |
| (wt %) | | | | | |
| Polyol 1 | 88.5 | 63.5 | 48.5 | 48.5 | — |
| Polyol 2 | — | — | — | — | 39 |
| Crosslinker 1 | — | — | — | — | 3 |
| Crosslinker 2 | 10 | 10 | 10 | 10 | — |
| Crosslinker 3 | — | — | — | — | 3 |
| Crosslinker 4 | — | — | — | — | 3 |
| Silicone surfactant 1 | 0.5 | 0.5 | 0.5 | 0.5 | — |
| Silicone surfactant 2 | — | — | — | — | 2.5 |
| Catalyst 1 | 0.3 | 0.3 | 0.3 | 0.3 | 0.3 |
| Blowing agent 1 | 0.7 | 0.7 | 0.7 | 0.7 | 1.2 |
| Liquid FR Additive - 1 | — | — | — | 40 | — |
| Liquid FR Additive - 2 | — | 25 | 40 | — | 48 |
| Total Isocyanate-reactive | 100 | 100 | 100 | 100 | 100 |
| component | | | | | |
| Isocyanate Component (wt %) | | | | | |
| Isocyanate 1 | 55 | 55 | 55 | 55 | 100 |
| Liquid FR Additive - 2 | — | — | — | — | — |
| Total Isocyanate Component | 55 | 55 | 55 | 55 | 100 |

TABLE 3
Formulations of comparative samples C6-C9 for Example 1

| Component | C6 | C7 | C8 | C9 |
|---|---|---|---|---|
| Isocyanate-reactive Component | | | | |
| (wt %) | | | | |
| Polyol 1 | — | 78.5 | 53.5 | 62.5 |
| Polyol 2 | 39 | — | — | — |
| Crosslinker 1 | 3 | — | — | — |
| Crosslinker 2 | | 10 | 10 | |
| Crosslinker 3 | 3 | — | — | — |
| Crosslinker 4 | 3 | — | — | 1 |
| Silicone surfactant 1 | — | 0.5 | 0.5 | 0.5 |
| Silicone surfactant 2 | 2.5 | — | — | — |
| Catalyst 1 | 0.3 | 0.3 | 0.3 | 0.3 |
| Blowing agent 1 | 1.2 | 0.7 | 0.7 | 1.2 |
| Liquid FR Additive - 2 | 48 | — | 20 | 15 |
| Solid FR Additive-1 | — | 15 | — | — |
| Solid FR Additive-2 | — | | 20 | 20 |
| Total Isocyanate-reactive | 100 | 105 | 105 | 100.5 |
| Isocyanate Component (wt %) | | | | |
| Isocyanate 1 | 80 | 55 | 50 | 30 |
| Liquid FR Additive - 2 | 20 | — | — | — |
| Total Isocyanate Component | 100 | 55 | — | 30 |

TABLE 4
Formulations of samples I1-I5 for Example 1

| Component | I1 | I2 | I3 | I4 | I5 |
|---|---|---|---|---|---|
| Isocyanate-reactive Component | | | | | |
| (wt %) | | | | | |
| Polyol 1 | 68.5 | 68.5 | 43.5 | 63.5 | 58.5 |
| Polyol 2 | — | — | — | — | — |
| Crosslinker 1 | — | — | — | — | — |
| Crosslinker 2 | 10 | 10 | 10 | 10 | 10 |
| Silicone surfactant 1 | 0.5 | 0.5 | 0.5 | 0.5 | 0.5 |
| Catalyst 1 | 0.3 | 0.3 | 0.3 | 0.3 | 0.3 |
| Blowing agent 1 | 0.7 | 0.7 | 0.7 | 0.7 | 0.7 |
| Solid FR Additive-1 | 20 | 15 | — | 20 | |
| Solid FR Additive-2 | — | 5 | — | 5 | 30 |
| Solid FR Additive-3 | — | — | 45 | — | — |
| Total Isocyanate-reactive | 100 | 100 | 100 | 100 | 100 |
| Isocyanate Component (wt %) | | | | | |
| Isocyanate 1 | 55 | 55 | 55 | 55 | 55 |
| Liquid FR Additive - 2 | — | — | — | — | — |
| Total Isocyanate part | 55 | 55 | 55 | 55 | 55 |

Sample formulations were then tested for a number of physical characteristics, listed below. Testing results for each formulation are shown in Tables 5-7.

UL 94 vertical burn test (1): The pottant material prepared in metal mold was then cut to 13 mm thickness with 13 mm and 125 mm dimensions using the procedure described above. The premade pottant samples (pottant alone) were tested with standard UL 94 vertical burn protocol and performance was categorized in appropriate category—V0 (best and desired performance), V1, V2, and fail (fail means the pottant sample burns all the way to the clamp during and/or after the flame exposure).

Density: Calculated as the density of the cured pottant plaque samples (i.e., weight/volume), performed pursuant to ASTM D3574-17 Test A. The weight of plaque was measured in gram, and the height of plaque was measured in cm. The width and thickness of plaques were 12.5 and 0.2 cm respectively. Density of pottant sample (in g/cm3): Weight of pottant sample*1000/(height*12.5*0.2).

Thermal conductivity: A Hot Disk AB TPS 2500S equipment with Kapton-insulated 5465 F1 sensor was utilized to measure the thermal conductivity as per ISO 22007-2 on the 2 mm thick pre-cured pottant samples with Isotropic (standard) module at 50 mW heating power and 5 second measurement time and standard analysis.

Elongation at break: For cured pottant plaque samples prepared using the procedure described above, Elongation at break (%) was obtained using ASTM 3574-17 Test E.

Hardness retention: Foam sampled were put in a 90° C. oven for 12 hours to equilibrate. After 12 hours, the Shore A hardness was measured according to ASTM D2240-21 within one minute. Hardness retention is calculated as the ratio of the Shore A hardness at 90° C. versus the Shore A hardness at 25° C.

Storage modulus retention: The storage modulus retention is defined as 100× [storage modulus at 90° C.]/[storage modulus at 25° C.]. Storage modulus measurements were obtained by dynamic mechanical analysis (DMA) according to ASTM D5279-21 on an Advanced Rheometric Expansion System (ARES-G2) from TA Instruments equipped with liquid nitrogen environmental control and torsion rectangular fixtures.

TABLE 5
Properties for comparative samples C1-C5

| Properties | Target | C1 | C2 | C3 | C4 | C5 |
|---|---|---|---|---|---|---|
| Liquid FR content in total composition (wt %) | — | 0 | 16 | 25.8 | 25.8 | 24 |
| Solid FR content in total composition (wt %) | — | 0 | 0 | 0 | 0 | 0 |
| Density (kg/m3) | ≤350 | 310 | 308 | 320 | 315 | 313 |
| Thermal conductivity (W/m*K) | ≤0.10 | 0.05 | 0.06 | 0.06 | 0.06 | 0.04 |
| Elongation (%) | ≥10 | 15.6 | 16.3 | 15.7 | 16.9 | 8.3 |
| UL-94 vertical burn at 13 mm | V1 or better | Fail | Fail | V1 | V0 | V1 |
| Hardness (Shore A, 25° C.) | ≥20 | 35 | 45 | 55 | 52 | 35 |
| Hardness retention | ≥60% | 90 | 40 | 11 | 11 | 2 |
| (%, Shore A, @90° C. versus @25° C.) | | | | | | |
| Storage Modulus retention | ≥60% | 77 | 43 | 24 | 18 | 1 |
| (%, @90° C. versus @25° C.) | | | | | | |

TABLE 6
Properties for comparative samples C6-C9

| Properties | Target | C6 | C7 | C8 | C9 |
|---|---|---|---|---|---|
| Liquid FR content in | — | 34 | 0 | 12.9 | 11.5 |
| total composition | | | | | |
| (wt %) | | | | | |
| Solid FR content in | — | 0 | 9.7 | 12.9 | 15.3 |
| total composition | | | | | |
| (wt %) | | | | | |
| Density (kg/m3) | ≤350 | 312 | 305 | 321 | 332 |
| Thermal conductivity | ≤0.10 | 0.04 | 0.06 | 0.06 | 0.06 |
| (W/m*K) | | | | | |
| Elongation (%) | ≥10 | 7.5 | 18.6 | 17.3 | 16.5 |
| UL-94 vertical burn | V1 or | V0 | Fail | V0 | V0 |
| at 13 mm | better | | | | |
| Hardness | ≥20 | 32 | 40 | 50 | 0 |
| (Shore A, 25 °C) | | | | | |
| Hardness retention | ≥60% | 0 | 91 | 45 | * |
| (%, @90 °C | | | | | |
| versus @25 °C) | | | | | |
| Storage Modulus | ≥60% | 0 | 78 | 49 | 52 |
| retention | | | | | |
| (%, @90 °C | | | | | |
| versus @25 °C) | | | | | |

* Typical flexible foam. The shore A hardness is zero at 25 °C and 90 °C

TABLE 7
Properties for comparative samples I1-I5

| Properties | Target | I1 | I2 | I3 | I4 | I5 |
|---|---|---|---|---|---|---|
| Liquid FR content | — | 0 | 0 | 0 | 0 | 0 |
| in total composition (wt %) | | | | | | |
| Solid FR content | — | 12.9 | 12.9 | 29 | 16 | 19.4 |
| in total composition (wt %) | | | | | | |
| Density (kg/m3) | ≤350 | 310 | 320 | 318 | 309 | 311 |
| Thermal conductivity (W/m*K) | ≤0.10 | 0.06 | 0.06 | 0.06 | 0.06 | 0.06 |
| Elongation (%) | ≥10 | 16.5 | 15.2 | 15.6 | 16.4 | 15.2 |
| UL-94 vertical burn at 13 mm | V1 or better | V0 | V0 | V1 | V0 | V0 |
| Hardness (Shore A, 25° C.) | ≥20 | 51 | 50 | 55 | 50 | 51 |
| Hardness retention | ≥60% | 90 | 90 | 87 | 79 | 68 |
| (%, Shore A, @90° C. versus @25° C.) | | | | | | |
| Storage Modulus retention | ≥60% | 73 | 74 | 72 | 75 | 65 |
| (%, @90° C. versus @25° C.) | | | | | | |

### Analysis

As shown, comparative example C1 without FR additive fails the UL-94 vertical burn test with no rating. Comparative example C2 contains 25 wt % of liquid FR additive TCPP in isocyanate reactive component, which also fails the UL-94 vertical burn test. Moreover, C2 loses hardness and storage modulus at 90° C.

Comparative samples C3 and C4 incorporate more liquid FR additive, which provide V1 and better performance during the UL-94 vertical burn test. However, the higher concentration of liquid FR additive in isocyanate-reactive component (40 wt % TCPP in C3 and 40 wt % TEP in C4) is accompanied by a loss of over 70% of hardness and storage modulus at high temperature. While the samples C5 and C6 have increased NCO indices (140 and 110, respectively), the elongation at break is below 10% and the samples exhibit a similar loss of hardness and storage modulus as with C₁-C₄.

Sample C7 uses solid FR at a low amount, which fails the UL-94 vertical burn test with no rating, but physical properties at high temperature is improved compare with liquid FR. Samples C8 and C9 contain formulations with a combination of solid and liquid FR additive, but that exhibit poor physical properties and hardness retention at high temperature. C9 was an example of typical flexible foam with a low concentration of crosslinker so that the hardness of theflexible foam is very low with a shore A hardness is zero, which is insufficient for most pottant applications.

Inventive samples I1 to 15 exhibited a fast cure (within 2 hours) at room temperature. Inventive sample I1 is a foam formulated with 20 wt % ALTP in isocyanate-reactive component, which achieves V0 during the UL-94 vertical burn test. When contrasted with similar formulation C2, the hardness and storage modulus change are much smaller than with the liquid FR additive. Inventive sample 12 contains a mixture of solid expandable graphite and ALTP, which achieves V0 during the UL-94 vertical burn test. 12 also exhibits improved hardness and storage modulus retention (greater than 70%) at 90° C. For 13, solid FR additive included APP at 45 wt % in the isocyanate-reactive component. Compared with C3 and C4 with 40 wt % liquid FR additives in the isocyanate-reactive component, 13 does not impair the hardness and storage modulus at high temperature. 14 demonstrates the effect of combination of APP and expandable graphite. At 25 wt % of the combination, 14 achieves V0 fire performance during the UL-94 vertical burn test and acceptable hardness and storage modulus at 90° C. 15 demonstrates the effect of expandable graphite in a PU foam that achieves V0 during the UL-94 vertical burn test, with hardness and storage modulus within the target specification.

While the foregoing is directed to exemplary embodiments, other and further embodiments may be devised without departing from the basic scope thereof, and the scope thereof is determined by the claims that follow.

1. A polyurethane composition, comprising a reaction product of:
an isocyanate component comprising one or more isocyanate compounds; and
an isocyanate-reactive component comprising:
one or more polyether polyols comprising at least one capped polyether polyol having an OH functionality of 3 to 6, and an EO content of 10 wt % to 25 wt %;
one or more polyol crosslinkers having a hydroxyl functionality of 2 or more; and
one or more solid flame resistance (FR) additives present at a percent by weight (wt %) ranging from 5 wt % to 35 wt % and selected from the group consisting of expandable graphite, carbon black, graphene, aluminum hypophosphite, hydrated aluminum hydroxide, ammonium polyphosphate, trioctyl phosphate ester, tributyl phosphate ester, tris-butoxyethyl phosphate ester, alkylphosphate oligomers, wollastonite, platinum compounds, calcium carbonate, red phosphorus, and sodium citrate, in at least one of the isocyanate component, the isocyanate-reactive component, or a third component;
wherein the polyurethane composition has a hardness of 20 Shore A or more.

2. The composition of claim 1, wherein the one or more solid FR additives are present at a percent by weight of the total composition (wt %) ranging from 10 wt % to 30 wt %.

3. The composition of claim 1, wherein the the one or more solid FR additives are one or more of expandable graphite, aluminum hypophosphite, and ammonium polyphosphate.

4. The composition of claim 1, further comprising a blowing agent.

5. The composition of claim 1, further comprising a silicone surfactant.

6. The composition of claim 1, wherein the one or more polyol crosslinker has a hydroxyl number in a range of 400 mg KOH/g to 2500 mg KOH/g.

7. The composition of claim 1, wherein the one or more polyol crosslinkers are present at a percent by weight (wt %) of the isocyanate-reactive components of 1 wt % to 25 wt %

8. The composition of claim 1, wherein the polyurethane composition has a density according to ASTM D3574-17 in a range of 0.2 g/L to 130 g/L.

9. A pottant prepared from the polyurethane composition of claim 1.

10. A method of preparing a polyurethane composition, comprising:
combining an isocyanate component comprising one or more isocyanate compounds; and
an isocyanate-reactive component comprising:
one or more polyether polyols comprising at least one capped polyether polyol having an OH functionality of 3 to 6, and an EO content of 10 wt % to 25 wt %;
one or more polyol crosslinkers having a hydroxyl functionality of 2 or more; and
one or more solid flame resistance (FR) additives present at a percent by weight (wt %) ranging from 5 wt % to 35 wt % and selected from the group consisting of expandable graphite, carbon black, graphene, aluminum hypophosphite, hydrated aluminum hydroxide, ammonium polyphosphate, trioctyl phosphate ester, tributyl phosphate ester, tris-butoxyethyl phosphate ester, alkylphosphate oligomers, wollastonite, platinum compounds, calcium carbonate, red phosphorus, and sodium citrate, in at least one of the isocyanate component, the isocyanate-reactive component, or a third component; and
reacting the mixture to form the polyurethane composition, wherein the polyurethane composition has a hardness of 20 Shore A or more.
